(19) United States
(12) Patent Application Publication
(10) Pub. No.: US 2004/0043806 A1
(43) Pub. Date: Mar. 4, 2004

(54) Online vehicle collection and play activity

(76) Inventors: Keith Kirby, Hermosa Beach, CA (US); Isaak Volynsky, Beverly Hills, CA (US)

Correspondence Address: KOLISCH HARTWELL, P.C., 520 S.W. YAMHILL STREET, SUITE 200, PORTLAND, OR, 97204, US

(21) Appl. No.: 10/361,157

(22) Filed: Feb. 7, 2003

Related U.S. Application Data
(60) Provisional application No. 60/355,002, filed on Feb. 8, 2002.
(60) Provisional application No. 60/354,973, filed on Feb. 8, 2002.

(51) Int. Cl. A63F 13/00

(52) U.S. Cl. 463/6

(57) ABSTRACT

An online game. More particularly, an online game in which virtual vehicles, particularly cars, may be selected, customized, and entered into races and other activities in an online community forum. In some embodiments, the online game may include a customization tutorial wherein virtual vehicles may be customized in a substantially reversible manner.

### CROSS REFERENCE TO RELATED APPLICATIONS

The present application claims priority from U.S. Provisional Patent Application Serial No. 60/355,002, filed Feb. 8, 2002, incorporated herein by reference in its entirety for all purposes.

### FIELD OF THE INVENTION

The present invention relates to an online game. More particularly, the invention relates to an online game in which virtual vehicles, particularly cars, may be selected, customized, and entered into races and other activities in an online community forum.

### BACKGROUND OF THE INVENTION

Networked computer entertainment, including online games, currently provide the capability of single-player, multi-player, and head-to-head competition in an online, networked environment. Examples of online games are found in U.S. Pat. Nos. 6,419,577; 6,325,292; 6,319,125; 6,280,325; 6,251,017; 6,224,486; and WO013788, the disclosures of which are incorporated herein by reference in their entirety for all purposes. Typically, such systems are designed for participants to pay an entrance fee in order to receive access, and then to play a game in return for possible prize rewards.

Character-based online games also exist wherein participants receive a character that can be directed to perform functions within a virtual universe, and these characters may in some instances be able to earn virtual game credits or points, which may subsequently be exchanged for additional attributes. Such attributes may improve the appearance and/or performance of the character within the context of the virtual universe.

### SUMMARY OF THE INVENTION

The present invention provides an online game, preferably provided by a web server to a plurality of terminals in communication with the web server through a communications network such as the internet, and available to users with a web browser. In one embodiment, the invention provides an online game interface and environment wherein a participant may choose a customizable virtual vehicle, which may be correlated to one or more actual purchased toy vehicles, and may receive an initial amount of virtual game credits useable for customizing the virtual vehicle. A customization activity is provided whereby participants may customize virtual vehicles in exchange for a reduction in the amount of virtual game credits, and a customization tutorial is also provided whereby participants may practice customizing virtual vehicles in a substantially reversible manner, without a reduction in the amount of virtual game credits.

The invention provides a variety of online activities involving customizable virtual vehicles, including both single-player and multi-player races and non-racing games in which customizable virtual vehicles may participate. These activities provide entertainment value, and a means for earning additional virtual game credits that may be used for further customization of vehicles. Single-player activities include non-racing, arcade-style game scenarios in which a virtual vehicle may participate, and in which participants may be rewarded for their performance, and also racing games in which a participant races a virtual vehicle against a computer-controlled vehicle or against the clock. Multi-player activities include multi-player races of various types in which a participant may enter their virtual vehicle and compete against other participants, possibly in real time through a communications network. In the context of the invention, “real time” indicates that competing virtual vehicles are simultaneously controlled by different users during a race or other competition. Participants may receive additional virtual game credits based on their performance in all of these activities.

Virtual vehicles provided by the invention may be associated with a hometown. The possible hometowns may be chosen from among actual, real-world locations, or they may have substantially no correlation to actual locations. The hometown association feature offers enhanced entertainment value to participants by allowing competition between hometowns, in which case participants associated with a given hometown may compete against participants associated with another hometown, possibly to establish a hometown ranking; and also by allowing competition between participants who are associated with the same hometown, possibly to establish an individual ranking.

Other features and advantages of the present invention will become apparent through an examination of the drawings and the detailed description.

### BRIEF DESCRIPTION OF THE DRAWINGS

FIG. 1 is a flowchart showing a range of steps associated with an embodiment of the present invention.

FIG. 2 is a flowchart showing an embodiment of a town center according to aspects of the present invention.

FIG. 3 is a flowchart showing general steps of a race according to an embodiment of the present invention.

FIG. 4 is a graphical representation of a town center portion of a preferred embodiment of the present invention.

FIG. 5 is a graphical representation of a vehicle customization activity in a preferred embodiment of the present invention.

FIG. 6 is another graphical representation of the vehicle customization activity of FIG. 5, illustrating storage of virtual spare parts.

FIG. 7 is another graphical representation of the vehicle customization activity of FIG. 5, illustrating installation of virtual parts.

FIG. 8 is another graphical representation of the vehicle customization activity of FIG. 5, illustrating an inventory of installed parts.

FIG. 9 is another graphical representation of the vehicle customization activity of FIG. 5, illustrating an inventory of stored spare parts.

FIG. 10 is a graphical representation of a hometown selection area according to a preferred embodiment of the present invention.

### DETAILED DESCRIPTION AND BEST MODE OF THE INVENTION

The present invention is an online collection and play activity, designed such that participants may collect and customize virtual vehicles, and enter their virtual vehicles in a variety of races and other activities.

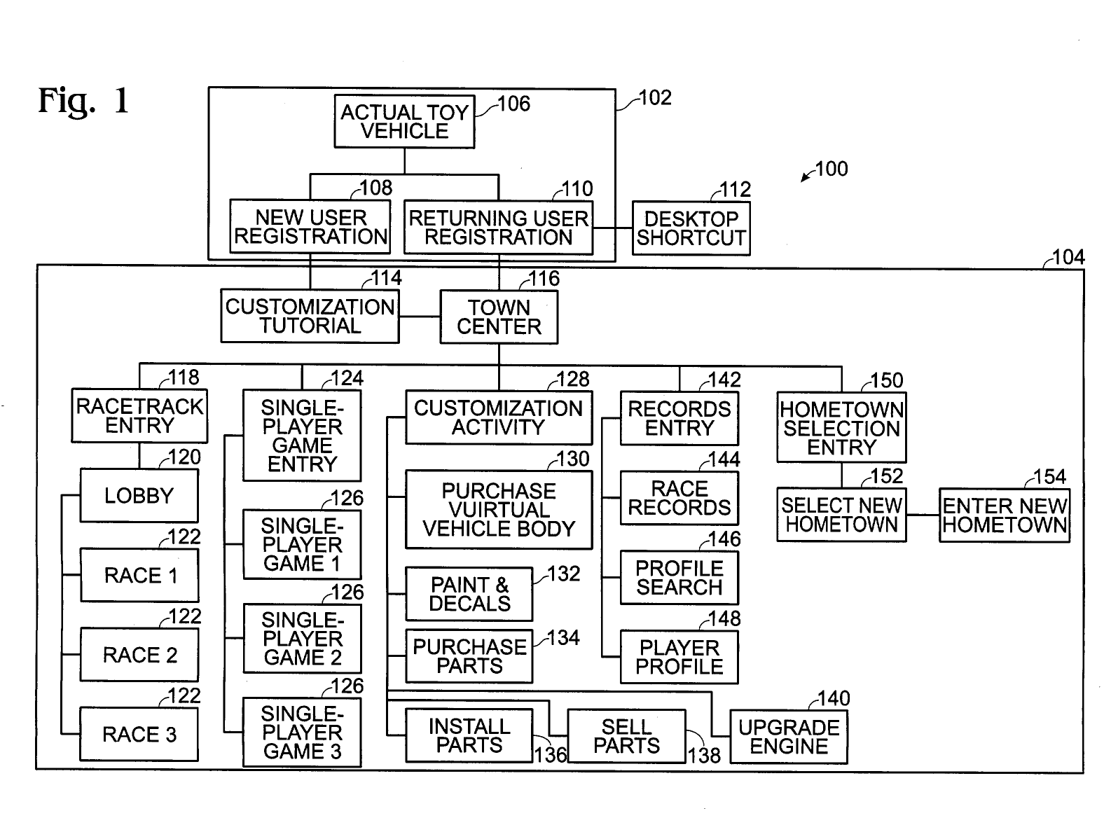

Referring to FIG. 1, a system 100 for playing an online game is disclosed. System 100 preferably comprises an off-server component 102, and a server 104 that in preferred embodiments is a web server. Off-server component 102 may include an actual toy vehicle 106, to be described in more detail below, as well as new user registration area 108 and returning user registration area 110. Participants may connect to server 104 via a communications network such as the internet, although the invention may also provide a server that is connected only to a local intranet, or that resides on a single processor that is not connected to a network.

Those skilled in the relevant arts will recognize that there are many configurations through which a game with an online component may be made available to participants. For instance, registration areas 108 and 110 may be installed on individual processors via a CD-ROM, DVD-ROM, other software storage media, and/or via download from the internet. Alternatively, system 100 may comprise a web server 104 which itself includes registration areas 108 and 110 in an integrated fashion. Or, the entire game may be stored and/or installed on a processor via any storage medium such as a CD-ROM, DVD-ROM, or any other medium suitable for storing one or more application programs.

A user may register for the game and connect to server 104 via either new user registration area 108 or returning user registration area 110. New user registration 108 for the online game typically includes choosing a unique user name and password, whereas returning user registration 110 typically includes entering an existing user name and password. At this point, a new user may be assigned a virtual vehicle for participation in the game, and a returning user may typically be re-associated with one or more virtual vehicles assigned and/or acquired through previous participation in the game.

Registration for the online game may be correlated to the purchase of an actual toy vehicle 106, in which case registrations 108 and/or 110 may include entering a code provided in or on the packaging of toy vehicle 106. Entering such a code may result in a user being assigned a virtual vehicle that represents toy vehicle 106 in various aspects, or it may result in a user gaining new virtual parts or game credits that may be used to customize virtual vehicles, as will be described in more detail below. New user registration 108 may also be configured to install a desktop shortcut 112 on a computer, providing quicker access to returning user registration area 110 when the game is played on subsequent occasions.

Considering an overview of the game elements provided by server 104 and still referring to FIG. 1, system 100 comprises customization tutorial 114, and the game may be configured so that new users initially enter tutorial 114 in order to practice customizing a virtual vehicle before entering the remainder of the online game system. From customization tutorial 114, a user may proceed to a town center 116, which may function as a primary hub for the logical architecture of the game. Returning users, who have presumably already passed through customization tutorial 114 at least once, may be directed straight from registration 110 to town center 116, without entering tutorial 114.

According to aspects of the invention, town center 116 may be designed as a primary central location from which many parts of the virtual game universe are directly accessible. Various aspects of the game that may be accessible from a town center in preferred embodiments will now be described.

From town center 116, a user may navigate to racetrack entry 118 in order to race a virtual vehicle against either a computer-generated opponent or against one or more virtual vehicles associated with other users. After passing through racetrack entry 118, a user may navigate to virtual lobby area 120, from which various races 122 may be joined. Further details of these races will be discussed below.

Also from town center 116, a user may navigate to a single-player game entry 124, from which a plurality of single-player games 126 may be chosen, including both vehicle racing games and non-racing, arcade-style games.

From town center 116, a user may also navigate to a customization activity 128. In customization activity 128, a user may customize a virtual vehicle in exchange for virtual game credits. Specific components of customization activity 128 include the purchase of a new virtual vehicle body 130, the purchase and installation of paint and decals 132, and the purchase of virtual parts 134. In addition, a user may navigate to a parts installation area 136, a parts sellback area 138, and an engine upgrade area 140. The customization features of the game will be described in greater detail below.

From town center 116, a user may navigate to a records entry area 142, where records related to the performance of various users and/or vehicles may be available. Area 142 may include a race records area 144, providing the results of multi-vehicle competitions; profile search area 146, from which a user may search for records related to another user; and player profile area 148, in which a user may update or alter their own personal player profile, which may be accessible by other users.

Also from town center 116, a user may navigate to hometown selection entry 150, from which they may proceed to select new hometown area 152, and to enter new hometown area 154. The hometown features of system 100 will be described in more detail below.

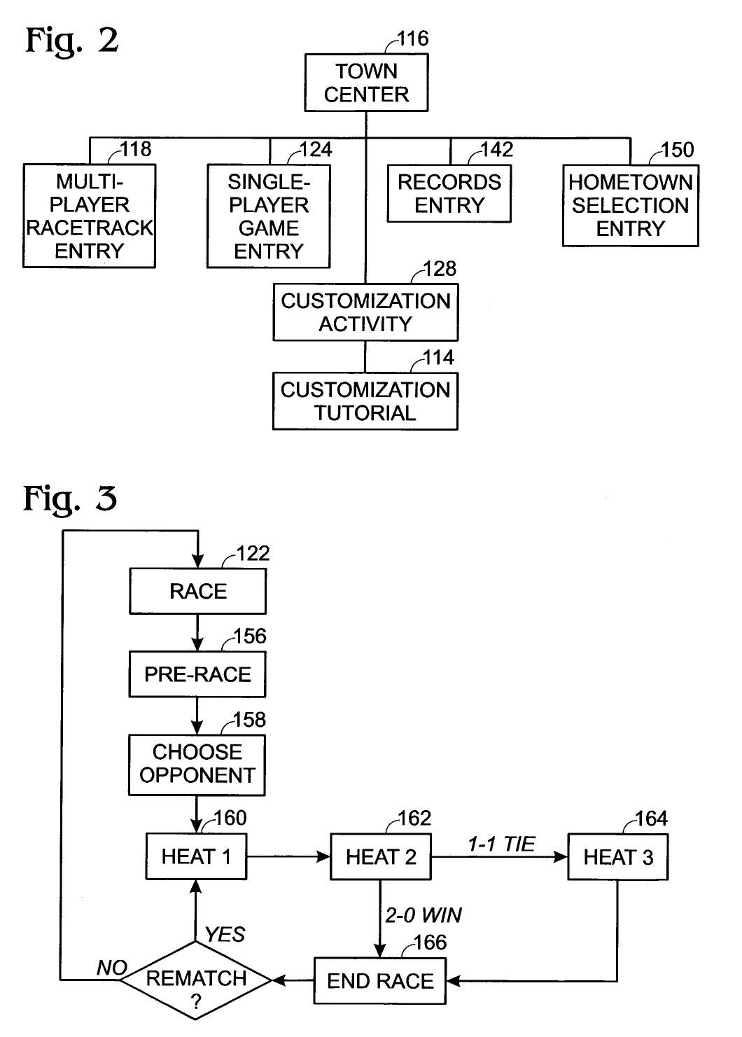

An alternate embodiment of the logical structure of town center 116 is indicated in FIG. 2. In this embodiment, a user may navigate from town center 116 to racetrack entry 118, single-player game entry 124, customization activity 128, records entry 142, and hometown selection entry 150, as in FIG. 1. However, customization tutorial 114 may be accessible from customization activity 128, allowing a user to easily pass back and forth between customization activity 128 and customization tutorial 114, so that skill in customizing a virtual vehicle may be gained intermittently, while customization is underway.

A preferred set of steps that may be part of race 122 is shown in FIG. 3. Components of race 122 may include a pre-race activity 156 in which a user may become familiar with a racetrack and may be given the opportunity to activate and/or deactivate certain virtual parts for optimal performance for a particular forthcoming race. Next, a user may be directed to a choose opponent area 158, in which characteristics of an opponent may be specified. These characteristics may include, for example, whether an opponent vehicle is human-controlled or entirely computer-controlled, an opponent's racing skill and/or experience level, and the amount of virtual credits that have been invested in an opponent's virtual vehicle.

Once pre-race activities are complete and an opponent has been selected, a race may begin with a first heat 160, and then may proceed to a second heat 162. In a preferred embodiment, the race may continue to a third heat 164 if the first two heats have resulted in a 1-1 tie, but may continue to an end race area 166 if the first two heats have resulted in a 2-0 victory for one of the opponents. End race area 166 may include activities such as a detailed review of the race statistics, or it may simply show a summary of the race results. A rematch option may be provided after the race ends, such that choosing to have a rematch leads to another first heat 160, and choosing not to have a rematch leads to race area 122, from which other aspects of the game such as town center 116 may be accessible.

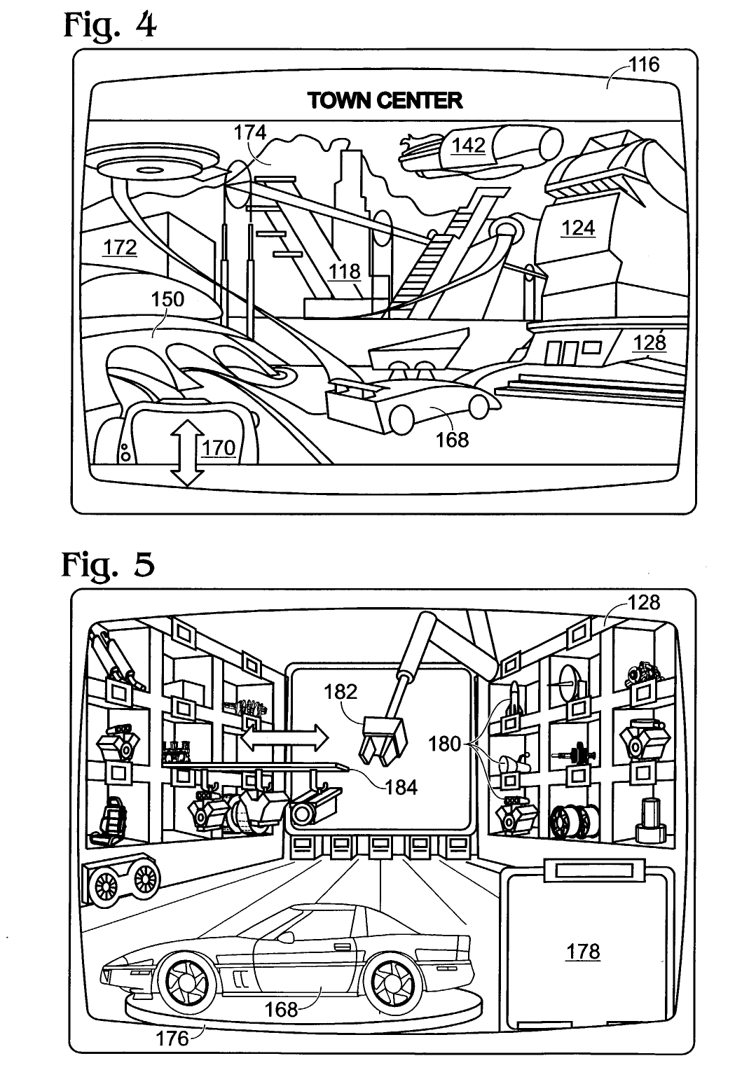

As described above, town center 116 may serve as a navigational hub for preferred embodiments of the online game. FIG. 4 shows a graphical representation of town center 116 in a preferred embodiment of the present invention, including graphical icons to represent many of the features previously described and illustrated in FIGS. 1 and 2. In FIG. 4, racetrack entry 118 is represented by an icon resembling a racetrack, single-player game entry 124 is represented by an icon resembling a video arcade game, customization activity 128 is represented by an icon resembling an auto mechanic's shop, records entry 142 is represented by an icon resembling a blimp, and hometown selection entry 150 is represented by an icon resembling a network of roads and/or tunnels. FIG. 4 also shows a graphical representation of a virtual vehicle 168, which in a preferred embodiment is a virtual car such as a virtual racecar. Town center 116 may also include a video display unit 170, which may display information such as the current hometown and the hometown population; an ocean cube 172, providing a link to underwater games; and a scrap yard 174, which may be a location for the storage of damaged or destroyed vehicles and/or spare parts.

Considering in greater detail various customization features of the online game, FIGS. 5-9 show graphical representations of customization activity 128 in a preferred embodiment of the present invention. Note that although FIGS. 5-9 represent aspects of customization activity 128, the features and descriptions represented therein apply equally well to customization tutorial 114, with exceptions that will be noted below. FIG. 5 shows customization activity 128, with virtual vehicle 168 resting on a rotatable platform 176. Platform 176 is configured to rotate in response to a user command such as a mouse movement, a mouse click, or a keystroke, so that a user may examine vehicle 168 from all angles during customization. For example, on the base of platform 176, there may be a means, such as a graphical icon or rollover mechanism, that will allow vehicle 168 to be rotated in a full circle one time.

Also shown in FIG. 5 is a display screen 178, which is preferably located in an area either behind or to the side of vehicle 168, so that screen 178 does not block other aspects of customization activity 128. Screen 178 is configured to display information about various vehicle parts, indicated at 180. Information displayed on screen 178 may be for a particular part, and may include a name; a price; a rarity; a power; an energy usage; and a general description, all for that part. Preferably, screen 178 is configured to display such information in “roll-over” fashion when the cursor is located on or near a corresponding vehicle part on the screen, in a manner familiar to those skilled in the art of web page design.

Vehicle parts 180 may include virtual engine parts, wheels, brakes, and other conventional auto parts, as well as weapons, defensive shields, and performance enhancers of various types, some of which may have no real world analog. Parts 180 may also include paint, decals, and other components designed to augment the appearance and/or performance of vehicle 168. Once selected, various parts may be installed in or on a virtual vehicle using robotic arm 182, which is configured to hold one of parts 180 in its robotic jaws and then to install that part into a virtual vehicle. Upon selection of a type of part, preferably by clicking on a corresponding icon with a mouse, a sliding shelf 184 will appear, holding specific and selectable individual parts. Selecting a specific part from shelf 184 results in the part being picked from the shelf by robotic arm 182, in preparation for installation into vehicle 168.

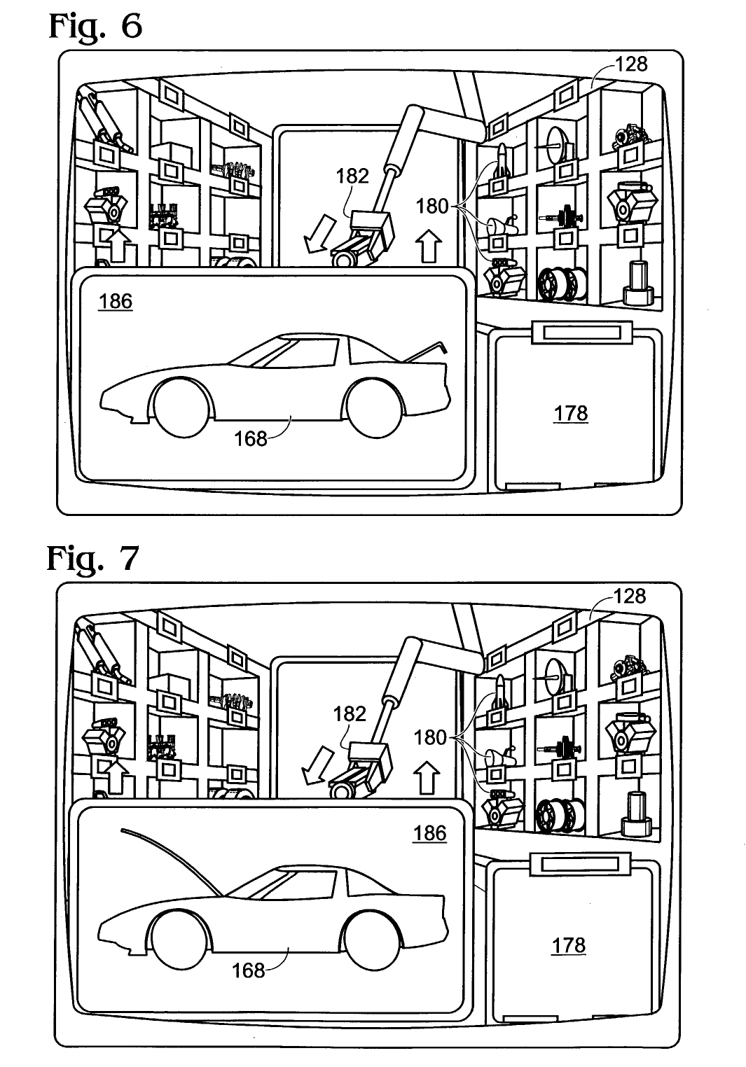

FIGS. 6 and 7 show alternate views of customization activity 128 during the installation of one of parts 180, including also inventory display 186. Inventory display 186 is preferably configured to remain out of sight unless activated by a user command or a cursor movement, for example a motion of the mouse pointer over virtual vehicle 168. Once activated, display 186 will slide upwards or otherwise appear, until it may completely intervene between a user's line of sight and vehicle 168. At this point, display 186 is preferably configured to display an x-ray or other semi-transparent view of vehicle 168, as is best seen in FIGS. 6-7.

If a specific vehicle part 180 has been selected, it will have been automatically procured by robotic arm 182, as described previously. In that event, clicking on a particular area of the semi-transparent representation of vehicle 168, such as on the hood portion, will cause the selected part to be installed in the vehicle. Clicking on another area of the semi-transparent representation of vehicle 168, such as on the trunk portion, will cause the selected part to be stored in the vehicle for possible future use.

In either case (installation or storage), the price of the part will be subtracted from the user's total amount of virtual game credits. If the user is merely practicing vehicle customization through the use of customization tutorial 114, then the purchased part will be removed and the virtual game credits will be restored to the user's account at the end of each operation, upon leaving tutorial 114, or at another suitable time, so that the customization will be substantially reversible. However, if the user is customizing a virtual vehicle in customization activity 128, then the credits will not be restored and the customization will be substantially irreversible.

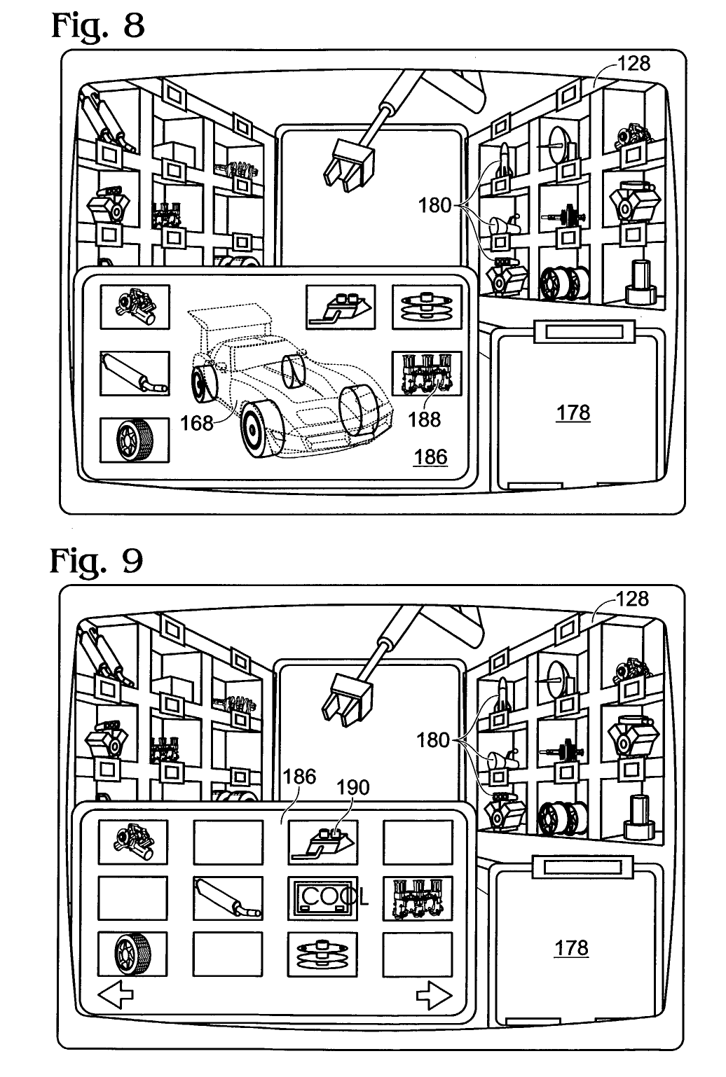

On the other hand, if a specific vehicle part 180 has not been selected when inventory display 186 is activated, then clicking on a particular area of the semi-transparent representation of vehicle 168, such as the hood portion, will cause an inventory of previously installed parts 188 to be displayed on inventory display 186, as is indicated in FIG. 8. Similarly, clicking on another area of the semi-transparent representation of vehicle 168, such as on the trunk portion, will cause an inventory of purchased and stored parts 190 to be displayed on inventory display 186, as is indicated in FIG. 9.

Addressing more particularly the subject of virtual game credits, upon first entering system 100, or a specific portion thereof such as customization activity 128 and/or customization tutorial 114, a user may receive an initial amount of virtual game credits. These game credits are provided for the purpose of customizing and/or upgrading virtual vehicles, and possibly for purchasing new virtual vehicles and parts. In customization activity 128, parts and/or other customization features are obtained by a user in return for a reduction in the amount of virtual game credits, and this reduction and the corresponding modifications made to a virtual vehicle are substantially irreversible. In tutorial 114, however, any reduction in the amount of virtual game credits provided will be reversed before a user leaves the tutorial, since a purpose of the tutorial is to allow reversible customization of a virtual vehicle for practice purposes. In this way, a user may determine how to add paint, stickers, decals, car parts, weapons and other components to a virtual vehicle using trial-and-error, in a substantially reversible way. Also, a user may determine exactly which combination of these various components they prefer to spend their virtual game credits on, as the amount initially provided is limited.

Increases in a user's amount of virtual game credits may occur as a result of being declared a winner in a competition such as a multi-player race, and for participation and/or performance in various single-player activities. The amount of virtual game credits available to a user will determine their ability to further customize their virtual vehicles, to purchase and customize new virtual vehicles, and thus to advance in skill and experience within the virtual online game provided by system 100.

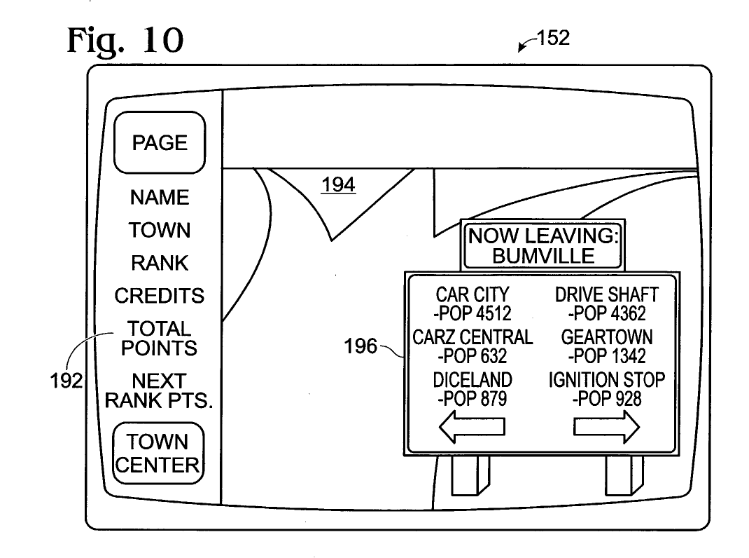

Considering now more details regarding hometown selection entry area 150, recall that this area leads to hometown selection area 152 and new hometown entry area 154. A graphical representation of a preferred embodiment of hometown selection area 152 is shown in FIG. 10. This selection area may include a display 192 showing various information about a user such as a user name, current hometown, player rank, available game credits, and so forth, as well as a link back to town center 116 and/or other areas of system 100. This information may be similar or identical in content to information available in player profile area 148, which is reached through record entry area 142. In addition, hometown selection area 152 may include a graphical representation of a fork 194 in a road, or other similar dividing point, indicating that choices are available as to a next hometown destination.

Selection of a new hometown may result simply from clicking on a branch of fork 194, or the various branches of fork 194 may be labeled with names or icons representing other hometowns (not indicated in the figures). Preferably, a hometown selection window 196 or other similar means is provided, possibly associated with a “roll-over” feature, to facilitate selection of a new hometown. The selection of a hometown may augment participation in the online game as follows. In some embodiments, a user may compete in races against other users associated with the same hometown, and receive an individual performance ranking within their hometown as a result of the outcomes of these competitions. On the other hand, members of a given hometown may challenge members of another hometown to competitive races, the outcomes of which may be used to determine a hometown performance ranking relative to other hometowns. In this manner, competition, teamwork and loyalty are all evoked within the context of an online game experience.

In addition to the components described above, the present invention comprises various audio elements designed to enhance a user's experience of the game. In a preferred embodiment, every time a user presses a button or makes a selection of some kind, a brief sound plays, as will now be described in greater detail.

A “Quiet Click” sound may result from relatively insignificant actions such as toggling a setting on and off. This sound may be heard rather frequently, and may therefore be chosen to be a generic clicking sound. This sound can also be used for mouse-down states. A “Standard Click” sound may result from more significant actions, such as canceling a process. This may also be a generic click sound, but louder than a “Quiet Click”. An “Important Click” is a sound that may play when a user has completed a process or action, such as clicking on a button that will take a user to a new location within system 100. An “Error Sound” may play when a user attempts an action that is incorrect or illegal, such as trying to purchase a virtual part that requires a greater amount of virtual game credits than the user currently has available. “Place Sounds” may be played that are correlated to various virtual locations within the game. For example, when a player first enters a new section of the game, a brief background sound may play, setting the scene for the new section. A background sound may comprise a 2-5 second sound that sets a mood and theme for the section. The table below shows components of the game, along with possible “Place Sounds”, according to a preferred embodiment of the invention:

| Game Component | “Place Sound” |
|---|---|
| entering town center | busy traffic |
| entering customization area | machine shop tools |
| entering blimp | “light saber” sound |
| entering racetrack | engine revving |
| entering arcade | video game sound effects |

A player's experience and skill at playing the various games that are comprised by the invention may be tabulated by a system of points and skill levels. Points may be awarded for performance in both single-player and multi-player games and races, and a player may be assigned a particular skill level according to the total number of points accumulated. In a preferred embodiment, there are seven levels in the game (1-7), and a user's level is based on the total number of points that a user has accumulated over time. The following chart indicates the total number of points that may be necessary to achieve different levels.

| User Level | Total Point |
|---|---|
| Level 1 | 0 |
| Level 2 | 100 |
| Level 3 | 1,000 |
| Level 4 | 10,000 |
| Level 5 | 100,000 |
| Level 6 | 500,000 |
| Level 7 | 1,000,000 |

In addition, new levels (level 8, level 9, Master level, etc.) may be created to accommodate more advanced users. In a preferred embodiment, level may play a role in the game in the following ways:

When users race, they may be automatically matched up against other users of the same level.

The number of engine upgrades a user can make on a particular engine may be determined by level. A Level 1 engine may begin with 10 points, and each level may allow for two engine upgrades of two energy each, for a maximum total of 4 additional energy points per level. This means that the maximum engine energy totals may be as follows:

| User Level | Maximum Total Energy |
|---|---|
| Level 1 | 14 |
| Level 2 | 18 |
| Level 3 | 22 |
| Level 4 | 26 |
| Level 5 | 30 |
| Level 6 | 34 |
| LeveL 7 | 38 |

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements and/or properties may be claimed in a related application. Such claims, whether they are directed to a different invention or directed to the same invention, whether different, broader, narrower or equal in scope to any original claims, are also regarded as included within the subject matter of the inventions of the present disclosure.

I claim:

1. A method of providing an online game accessible with a web browser, comprising:
providing a first amount of virtual game credits;
providing at least one virtual vehicle;
providing a customization tutorial allowing customization of the at least one virtual vehicle without a reduction in the first amount of virtual game credits; and
providing a customization activity allowing customization of the at least one virtual vehicle with a reduction in the first amount of virtual game credits.

2. The method of claim 1, where the at least one virtual vehicle is a virtual racecar.

3. The method of claim 2, further comprising providing a multi-car race for at least two virtual vehicles, wherein there is at least one winner associated with the multi-car race, and wherein the at least one winner receives a second amount of virtual game credits.

4. The method of claim 3, wherein each of the at least two virtual vehicles is associated with a hometown.

5. The method of claim 4, wherein the at least two virtual vehicles are associated with the same hometown.

6. An online entertainment system comprising:
a web server accessible through a communications network; and
a game provided by the web server, including:
at least one virtual racecar;
a first amount of virtual game credits associated with the at least one virtual race car;
a customization tutorial allowing alterations to the at least one virtual race car without a reduction in the first amount of virtual game credits; and
a customization activity allowing alterations to the at least one virtual racecar in return for a reduction in the first amount of virtual game credits.

7. The on-line entertainment system of claim 6, further comprising a competition between virtual race cars, wherein there is at least one winner associated with an outcome of the competition, and wherein the at least one winner receives a second amount of virtual game credits.

8. The on-line entertainment system of claim 7, further comprising a plurality of hometowns, and wherein each at least one virtual racecar is associated with a hometown.

9. The on-line entertainment system of claim 8, wherein the competition is configured such that only virtual racecars associated with the same hometown are allowed to participate.

10. An electronic game comprising:
at least one virtual vehicle;
virtual game credits; and
a customization tutorial;
wherein the at least one virtual vehicle is customizable in exchange for a portion of the virtual game credits; and
wherein the customization tutorial is configured to allow the at least one virtual vehicle to be reversibly customizable without an expenditure of the virtual game credits.

11. The game of claim 10, wherein each at least one virtual vehicle is associated with a hometown.

12. The game of claim 11, where the at least one virtual vehicle is a virtual racecar.

13. The game of claim 12, further comprising a competition between at least two virtual racecars, wherein the at least two virtual racecars are associated with the same hometown.

14. The game of claim 12, further comprising a web server and a plurality of terminals in communication with the web server through a communications network.

15. An on-line game comprising:
a game interface accessible by a web browser through a communications network;
at least two virtual race cars;
at least two hometowns; and
at least one race between the at least two virtual race cars;
wherein each of the at least two virtual race cars is associated with one of the at least two hometowns; and
wherein the at least one race is configured to allow participation only by virtual racecars associated with the same hometown.

16. The on-line game of claim 15, further comprising:
an amount of virtual game credits associated with each of the at least two virtual race cars;
a customization activity, wherein each of the at least two virtual race cars may be customized by addition of virtual paint, stickers and parts in exchange for a reduction in the amount of virtual game credits; and
a customization tutorial, wherein each of the at least two virtual race cars may be temporarily customized without the reduction.

17. The on-line game of claim 16, further comprising at least one single-player game, wherein participation in the at least one single-player game results in an increase in the amount of virtual game credits.

18. An on-line game interface accessible by a web browser, wherein the game interface grants an amount of virtual game credits to a user; allows the user to select a virtual vehicle; allows the user to customize the virtual vehicle in exchange for a portion of the virtual game credits; allows the user to create a virtual profile; allows the user to race the virtual vehicle against other virtual vehicle; and allows the user to enter the virtual vehicle into a plurality of single-player non-racing games.

19. The on-line game interface of claim 18, wherein the game interface further allows the participant to reversibly customize the virtual vehicle without a reduction in the amount of virtual game credits.

20. An on-line automobile game comprising:
a registration area allowing registration for the game and providing a first virtual car; and
a town center providing a plurality of selectable activities, including:
a profile creation activity allowing creation of a personalized player profile;
a customization activity providing an amount of virtual game credits and allowing customization of the first virtual car in exchange for a reduction in the amount of virtual game credits, said customization including the addition of paint, stickers, car parts, and weapons to the first virtual car;
a multi-player racing activity allowing the first virtual car to compete against at least a second virtual car;
a hometown selection activity including the option to associate a hometown with the first virtual car and to change hometowns; and
at least one single-player game activity;
wherein the customization activity includes a tutorial allowing customization of the first virtual car without the reduction in the amount of virtual game credits;
wherein the multi-player racing activity allows the first virtual car to compete against the at least a second virtual car only if the first virtual car and the at least a second virtual car are associated with the same hometown; and
wherein the at least one single-player game activity includes at least one non-racing game.

21. A method of playing an on-line automobile game comprising:
communicating with a web server through a communications network;
registering for the game and selecting a user name;
receiving a virtual car;
receiving an amount of virtual game credits;
reversibly customizing the virtual car;
irreversibly customizing the virtual car; and
entering the virtual car in at least one play activity;
wherein reversibly customizing the virtual car does not cause a reduction in the amount of virtual game credits, and wherein irreversibly customizing the virtual car does cause a reduction in the amount of virtual game credits.

22. The method of claim 21, where the at least one play activity comprises a multi-player race.

23. The method of claim 22, where the multi-player race occurs in real time.

24. The method of claim 21, where the at least one play activity comprises a single-player, non-racing game.

25. A storage medium storing an application program for a car racing game comprising:
a town center providing a plurality of selectable activities, including:
a profile creation activity allowing creation of a personalized player profile;
a customization activity providing an amount of virtual game credits and allowing customization of the first virtual car in exchange for a reduction in the amount of virtual game credits, said customization including the addition of paint, stickers, car parts, and weapons to the first virtual car;
a multi-player racing activity allowing the first virtual car to compete against at least a second virtual car; and
a hometown selection activity including the option to associate a hometown with the first virtual car and to change hometowns;
wherein the customization activity includes a tutorial allowing customization of the first virtual car without the reduction in the amount of virtual game credits; and
wherein the multi-player racing activity allows the first virtual car to compete against the at least a second virtual car only if the first virtual car and the at least a second virtual car are associated with the same hometown.

26. A storage medium storing an application program for a car racing game as recited in claim 25, wherein the multi-player racing activity takes place in real time.

27. A storage medium storing an application program for a car racing game as recited in claim 26, further comprising at least one single-player activity.

28. A storage medium storing an application program for a car racing game as recited in claim 27, where the at least one single-player activity includes at least one non-racing game.
